(19) United States
(12) Patent Application Publication
(10) Pub. No.: US 2018/0006414 A1
(43) Pub. Date: Jan. 4, 2018

(54) CONDUCTIVE MEMBER AND ELECTRIC CONNECTION BOX

(71) Applicant: Yazaki Corporation, Tokyo (JP)

(72) Inventors: Manabu OOISHI, Shizuoka (JP); Kikuo OGAWA, Shizuoka (JP)

(73) Assignee: Yazaki Corporation, Tokyo (JP)

(21) Appl. No.: 15/622,279

(22) Filed: Jun. 14, 2017

(30) Foreign Application Priority Data
Jun. 30, 2016 (JP) 2016-130309

(51) Int. Cl. H01R 25/16; H02G 3/08; H02G 5/08; H02G 5/10

(52) U.S. Cl. CPC H01R 25/162; H02G 5/10; H02G 3/081; H02G 3/088; H02G 5/08

(57) ABSTRACT

Conductive members include a conductive plate member having first surface regions and second surface regions having a surface roughness value higher than that of the first surface region. The conductive member may have terminal portions electrically connected to other components, and the second surface region may be a region excluding at least contact surfaces with other components. The second surface region may be exposed to a surrounding space.

### CROSS-REFERENCE TO RELATED APPLICATION(S)

The present application claims priority to and incorporates by reference the entire contents of Japanese Patent Application No. 2016-130309 filed in Japan on Jun. 30, 2016.

### BACKGROUND OF THE INVENTION

### 1. Field of the Invention

The present invention relates to a conductive member and an electric connection box.

### 2. Description of the Related Art

In the background art, a heat dissipation member is sometimes employed in an electric connection box and the like. For example, Japanese Patent Application Laid-open No. 2006-93404 discloses a technique of an electric connection box including a circuit assembly provided with a control circuit board embedded with electric components and a busbar, a heat dissipation member provided on a surface of the busbar opposite to the control circuit board by interposing an insulation layer, and a casing for housing the circuit assembly and the heat dissipation member.

There is a demand for further improvement in the technique of suppressing a temperature increase of an electric component or the like. For example, it is desirable to improve a heat dissipation capability without increasing the number of components. It is possible to suppress an increase of the number of components if the heat dissipation member can be omitted, or an increase of the heat dissipation member can be suppressed while the heat dissipation capability is secured.

### SUMMARY OF THE INVENTION

An object of the present invention is to provide a conductive member and an electric connection box capable of suppressing an increase of the number of components and improving the heat dissipation capability.

A conductive member according to one aspect of the present invention includes a conductive plate member including a first surface region and a second surface region having a surface roughness value higher than that of the first surface region.

According to another aspect of the present invention, it is preferable that the conductive member further includes a terminal portion electrically connected to other components, wherein the second surface region is a region excluding at least a contact surface with the other components.

According to still another aspect of the present invention, in the conductive member, it is preferable that the second surface region is exposed to a surrounding space.

According to still another aspect of the present invention, in the conductive member, it is preferable that the second surface region is subjected to surface finishing for increasing a surface roughness value of the plate member.

According to still another aspect of the present invention, in the conductive member, it is preferable that the surface finishing is etching.

An electric connection box according to still another aspect of the present invention includes a conductive member including a conductive plate member provided with a first surface region and a second surface region having a surface roughness value higher than that of the first surface region; and a casing that houses the conductive member.

According to still another aspect of the present invention, in the electric connection box, it is preferable that the casing has a ventilation hole facing the second surface region.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view illustrating an electric connection box according to an embodiment;

FIG. 2 is an exploded perspective view illustrating an electric connection box according to an embodiment;

FIG. 3 is a plan view illustrating a busbar according to an embodiment;

FIG. 4 is an enlarged cross-sectional view illustrating a second surface region according to an embodiment;

FIG. 5 is a simplified cross-sectional view illustrating a second surface region according to an embodiment;

FIG. 6 is an explanatory diagram illustrating temperature measurement using a sample;

FIG. 7 is a schematic diagram illustrating where thermocouples used in the temperature measurement are arranged;

FIG. 8 is a diagram illustrating a result of the temperature measurement;

FIG. 9 is a perspective view illustrating a busbar of a comparative example;

FIG. 10 is a perspective view illustrating a busbar according to a second modification of the embodiment; and

FIG. 11 is a plan view illustrating an electric connection box according to a third modification of the embodiment.

### DETAILED DESCRIPTION OF THE PREFERRED EMBODIMENTS

A conductive member and an electric connection box according to an embodiment of the present invention will now be described in details with reference to the accompanying drawings. Note that the present invention is not limited to such an embodiment. In addition, elements of the embodiment described below also encompass those readily conceivable by a person ordinarily skilled in the art or substantially equivalent thereto.

### Embodiment

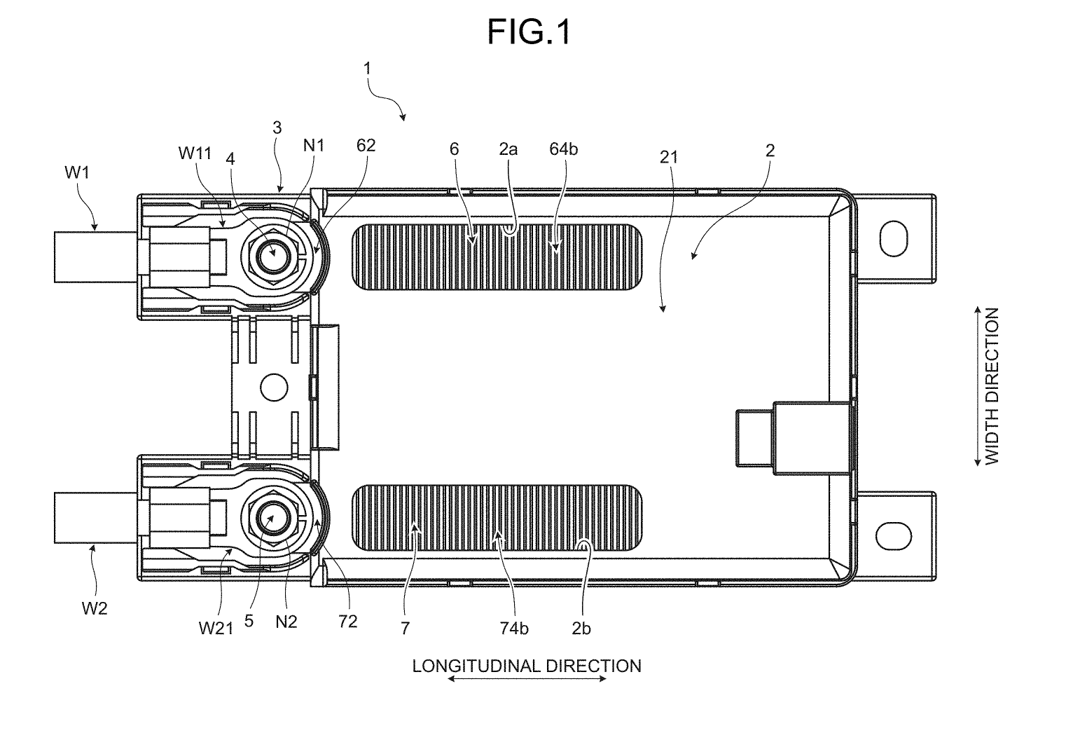

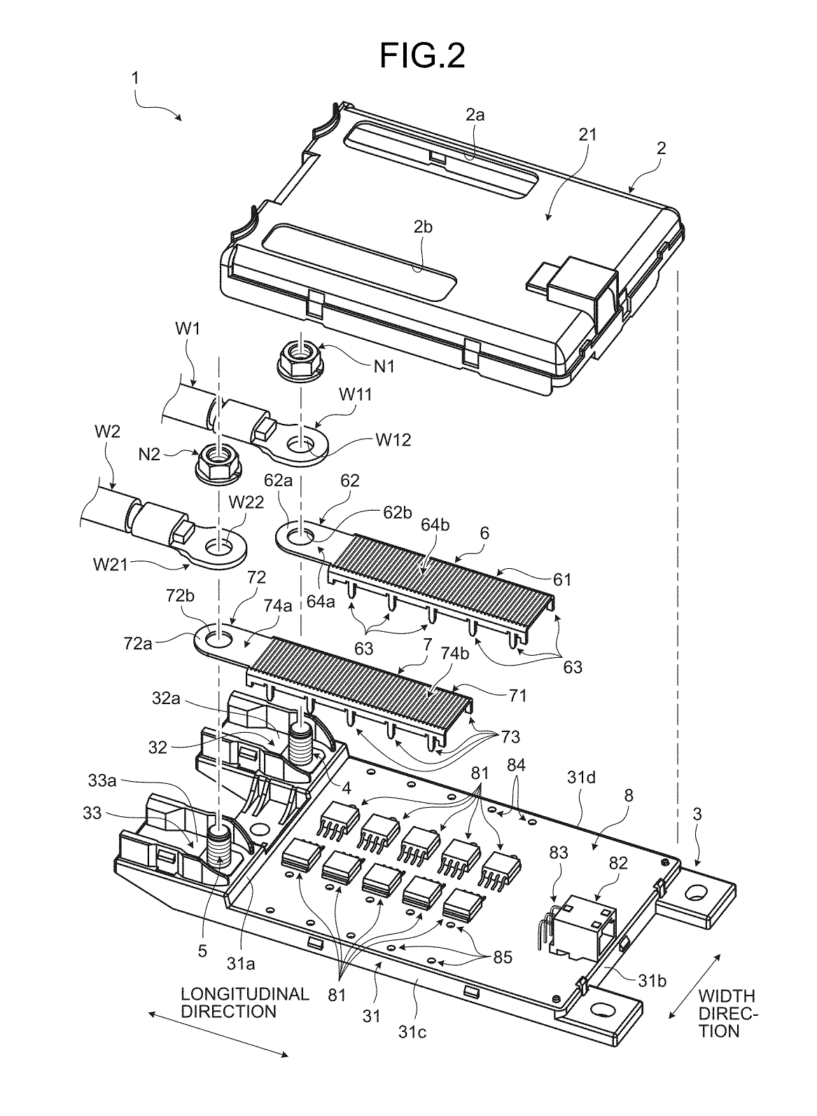

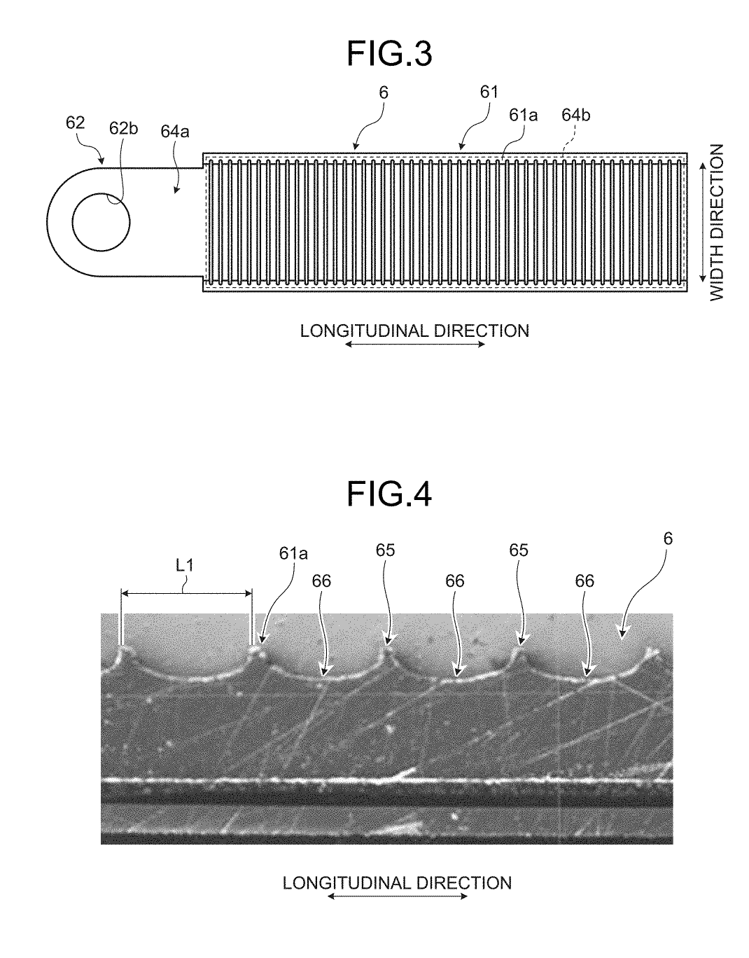

Embodiments will be described with reference to FIGS. 1 to 8. This embodiment relates to a conductive member and an electric connection box. FIG. 1 is a plan view illustrating an electric connection box according to an embodiment. FIG. 2 is an exploded perspective view illustrating an electric connection box according to an embodiment. FIG. 3 is a plan view illustrating a busbar according to an embodiment. FIG. 4 is an enlarged cross-sectional view illustrating a second surface region according to an embodiment. FIG. 5 is a simplified cross-sectional view illustrating a second surface region according to an embodiment.

The electric connection box 1 according to an embodiment illustrated in FIG. 1 or the like controls distribution and/or supply of electric power to a plurality of devices. As illustrated in FIG. 1, the electric connection box 1 includes an upper cover 2, a lower cover 3, posts 4 and 5, and busbars 6 and 7. The electric connection box 1 is sometimes called a junction box, a fuse box, a relay box, or the like. In this embodiment, they will be generally called an “electric connection box.” The upper and lower covers 2 and 3 are assembled with each other to form a casing that houses a circuit board 8, an electric component 81, and busbars 6 and 7 illustrated in FIG. 2. The upper and lower covers 2 and 3 are formed of an insulation material such as synthetic resin.

As illustrated in FIG. 2, the lower cover 3 has a main body 31, a first terminal holding portion 32, and a second terminal holding portion 33. The main body 31 is a rectangular parallelepiped box-shaped component whose one side is opened. The main body 31 according to this embodiment has a rectangular shape as seen in a plan view.

The main body 31 has a pair of side wall portions 31a and 31b facing each other in a longitudinal direction, and a pair of side wall portions 31c and 31d facing each other in a width direction. The side wall portions 31a, 31b, 31c, and 31d form a housing portion that houses the circuit board 8. The terminal holding portions 32 and 33 protrudes from the side wall portion 31a in the longitudinal direction. The terminal holding portions 32 and 33 are formed integrally with the main body 31. The first terminal holding portion 32 is disposed in one end of the width direction of the side wall portion 31a, and the second terminal holding portion 33 is disposed in the other end of the width direction of the side wall portion 31a. The terminal holding portions 32 and 33 have holding surfaces 32a and 33a, respectively. The terminal holding surfaces 32a and 33a hold the terminal portions 62 and 72 of the busbars 6 and 7 and the terminals W11 and W21. The terminal holding surfaces 32a and 33a are surfaces directed to an open direction of the main body 31, that is, surfaces perpendicular to the longitudinal direction and the width direction of the main body 31.

The first and second posts 4 and 5 are held by the terminal holding portions 32 and 33 and protrude from the terminal holding surfaces 32a and 33a. The posts 4 and 5 protrude from the terminal holding surfaces 32a and 33a toward the upper cover 2 side. The posts 4 and 5 have a circular column shape and are threaded on their outer circumferential surfaces.

The upper cover 2 is a lid portion that blocks an opening of the main body 31 of the lower cover 3. The upper cover 2 is a rectangular parallelepiped box-shaped member whose one side is opened. The upper cover 2 forms a housing space for housing the circuit board 8, the busbars 6 and 7, and the like along with the lower cover 3. The upper cover 2 is provided with ventilation holes 2a and 2b. The ventilation holes 2a and 2b are formed in a top plate 21 of the upper cover 2. The top plate 21 is a wall portion facing the busbars 6 and 7 and the circuit board 8.

The terminal portions 62 and 72 of the busbars 6 and 7 are provided with through-holes 62b and 72b, respectively. In addition, the terminals W11 and W21 are provided with through-holes W12 and W22, respectively. The first post 4 is fastened with a nut N1 through the through-hole 62b of the terminal portion 62 and the through-hole W12 of the terminal W11. The terminal portion 62 and the terminal W11 are fixed with the nut N1 in combination and are electrically connected to each other. The second post 5 is fastened with a nut N2 through the through-hole 72b of the terminal portion 72 and the through-hole W22 of the terminal W21. The terminal portion 72 and the terminal W21 are fixed with the nut N2 in combination and are electrically connected to each other. An electric wire W1 is electrically connected to the terminal W11, and an electric wire W2 is electrically connected to the terminal W21. One of the electric wires W1 and W2 is connected to a power source such as a battery, and the other electric wire is connected to the ground. Note that another electric connection box or a transformer may be interposed between the electric connection box 1 and the power source or between the electric connection box 1 and the ground.

The circuit board 8, the main bodies 61 and 71 of the busbars 6 and 7, and the like are housed in the casing formed by the upper and lower covers 2 and 3. The circuit board 8 has a control circuit that distributes electric power to each electric load supplied from the power source through the busbars 6 and 7. This control circuit has various electric components 81. The electric component 81 includes an electric control unit (ECU), a relay, a fuse, and the like. In addition, a connector 82 is disposed on the circuit board 8. A plurality of terminals 83 are fixed to the connector 82. The terminal 83 is an output terminal of the control circuit and is electrically connected to a corresponding load.

The first and second busbars 6 and 7 are formed from a conductive plate member. The busbars 6 and 7 according to this embodiment are formed from a metal plate having electric conductivity such as a copper plate. The busbars 6 and 7 are formed by shearing or bending, for example, a metal plate as a source material using a press machine or the like.

The first busbar 6 has a main body 61, a terminal portion 62, and a plurality of leg portions 63. The main body 61, the terminal portion 62, and the leg portion 63 are integrated into a single body. The main body 61 is a tabular component. The main body 61 according to this embodiment has a rectangular shape. The terminal portion 62 is a tabular component protruding from one end of the longitudinal direction of the main body 61. The terminal portion 62 has a width, for example, approximately equal to that of the main body 61. A contact surface 62a of the terminal portion 62 is a surface coming into contact with the terminal W11. The contact surface 62a is a flat surface making surface contact with the terminal W11. The leg portions 63 are bent perpendicularly to the main body 61. A plurality of leg portions 63 are provided in each of both long sides of the main body 61 along the longitudinal direction. The leg portion 63 is welded to the control circuit of the circuit board 8. More specifically, a plurality of through-holes 84 where the leg portions 63 are inserted are provided in the circuit board 8. The leg portion 63 is inserted into the through-hole 84, and a tip of the leg portion 63 is electrically connected to the control circuit through welding. Therefore, the first busbar 6 is a conductive member that electrically connects the control circuit of the circuit board 8 and the electric wire W1.

The second busbar 7 is configured similar to the first busbar 6. The second busbar 7 has a main body 71 similar to the main body 61, a terminal portion 72 similar to the terminal portion 62, and a plurality of leg portions 73 similar to the leg portions 63. A contact surface 72a of the terminal portion 72 is a surface coming into contact with the terminal W21. The contact surface 72a is a flat surface making surface contact with the terminal W21. The leg portion 73 is inserted into the through-hole 85 provided in the circuit board 8. A tip of the leg portion 73 is electrically connected to the control circuit of the circuit board 8 through welding. Therefore, the second busbar 7 is a conductive member that electrically connects the control circuit of the circuit board 8 and the electric wire W2.

As illustrated in FIG. 3, the first busbar 6 has a first surface region 64a and a second surface region 64b. The first and second surface regions 64a and 64b are different regions on the surface of the first busbar 6. The first surface region 64a is a region on the surface of the first busbar 6 excluding the second surface region 64b. The second surface region 64b has a surface roughness value higher than that of the first surface region 64a. In other words, the second surface region 64b has a surface irregularity level higher than that of the first surface region 64a. Therefore, the second surface region 64b has a larger surface area per unit area of the region than that of the first surface region 64a. Accordingly, the second surface region 64b has a higher heat dissipation capability and can efficiently radiate heat to a surrounding space.

In the first busbar 6 according to this embodiment, the second surface region 64b is formed in at least a part of the main body 61. More specifically, the second surface region 64b is provided on the entire outer surface 61a of the main body 61. Here, the outer surface 61a refers to a surface of the main body 61 opposite to the circuit board 8 side, that is, a surface facing the upper cover 2. A plurality of small unevennesses are formed on the second surface region 64b through surface finishing. According to this embodiment, a plurality of grooves are formed on the second surface region 64b. The grooves on the second surface region 64b extend in the width direction of the first busbar 6. As illustrated in FIG. 2, similar to the first busbar 6, the second busbar 7 has a first surface region 74a and a second surface region 74b. The second surface region 74b is set in the same position and the same range as those of the second surface region 64b.

As illustrated in FIG. 4, a plurality of grooves 66 are formed on the outer surface 61a of the first busbar 6. A plurality of grooves 66 are neighbored to each other in the longitudinal direction of the first busbar 6. In addition, the grooves 66 are arranged with a predetermined pitch L1 in the longitudinal direction. According to this embodiment, the grooves 66 are arranged at equal pitch. The grooves 66 according to this embodiment are formed through etching. In the etching of the outer surface 61a, masking is performed such that flat portions 65 remain between the grooves 66. As a result, as seen in a plan view, the neighboring grooves 66 are partitioned by the flat portions 65.

In this manner, the outer surface 61a provided with the grooves 66 has a larger surface area, compared to a case where no groove 66 is provided. Here, an increase of the heat dissipation capability caused by forming the grooves 66 will be described. First, an increase of the surface area caused by forming the grooves 66 will be described. The surface area of the first surface region 64a is calculated as follows. FIG. 5 is a simplified cross-sectional view illustrating the first busbar 6. As recognized from FIG. 4, the groove 66 has an approximately U-shaped cross-sectional shape. Therefore, the wall surface of the groove 66 can be regarded as a combination of a plane portion 66a and an arc portion 66b as illustrated in FIG. 5. The plane portion 66a is a wall surface perpendicular to the longitudinal direction of the first busbar 6. The arc portion 66b is a wall surface on the bottom of the groove 66. The arc portion 66b is a wall surface having an arc-shaped cross section and is formed by linking a pair of plane portions 66a. Since the plane portion 66a is formed, the surface area, that is, the heat dissipation area increases, compared to a case where the outer surface 61a is flat. In addition, since the arc portion 66b is curved, the surface area increases, compared to the outer surface 61a is flat.

On the basis of the photographic image of FIG. 4, dimensions of the plane portion 66a, the arc portion 66b, and the flat portion 65 of the first surface region 64a were measured. The photographic image was obtained using an optical microscope (Model No. MF-B2017B) manufactured by Mitutoyo Corporation. The surface area of the first surface region 64a was calculated from each dimension of the plane portion 66a, the arc portion 66b, and the flat portion 65. This surface area is a total sum of the area of the plane portion 66a, the area of the arc portion 66b, and the area of the flat portion 65. In the temperature measurement described below, a sample having the surface area 1.3 times larger than a region area was employed. Here, the region area is an area of the first surface region 64a assuming that the first surface region 64a is smooth. That is, the region area is a substantial surface area of the outer surface 61a when no groove 66 is provided.

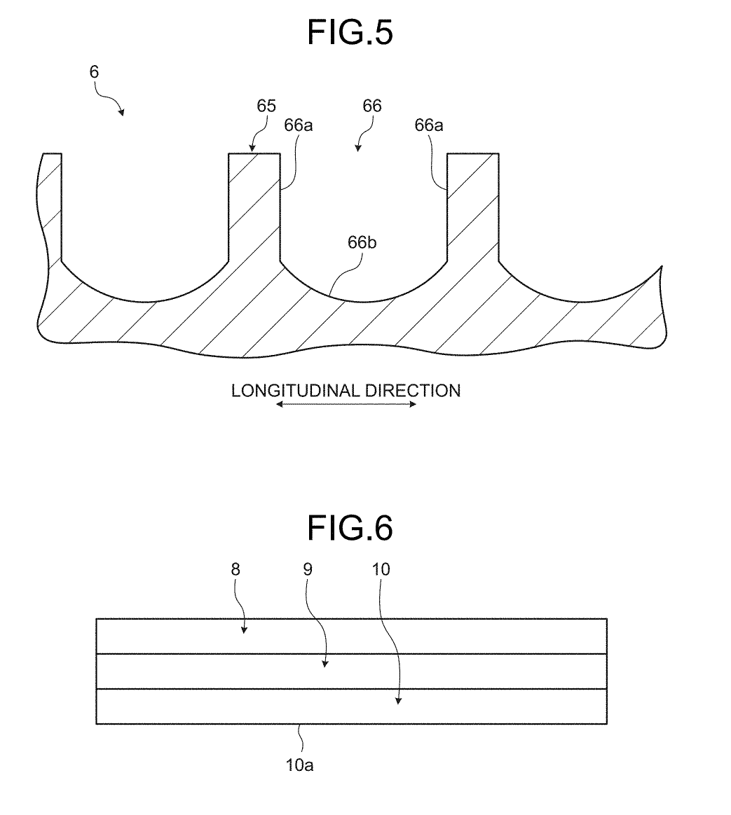

A change of the heat dissipation capability caused by providing the grooves 66 was measured using the tabular sample 10 of FIG. 6. The sample 10 used in the temperature measurement is formed from a plate member as in the first busbar 6. The sample 10 has a rectangular flat shape as seen in a plan view. The sample 10 has a thickness of 0.52 [mm]. Similar to the first surface region 64a of the first busbar 6, the grooves 66 are formed on the entire outer surface 10a of the sample 10.

The sample 10 is fixed to the circuit board 8 by interposing a heat conductive material 9. As the heat conductive material 9, a high-temperature conductive adhesive sheet (Model No. AD-7200TX) manufactured by RISHO KOGYO CO., LTD. was employed. The heat conductive material 9 has a thickness of 1.00 [mm]. The circuit board 8 has a thickness of 1.6 [mm] and is obtained by stacking a copper foil, a base material, a copper foil, a copper plate, and a resist on both surfaces of the core material having a thickness of 1.00 [mm]. The circuit board 8, the heat conductive material 9, and the sample 10 have a length of 116 [mm] and a width of 94 [mm]. The circuit board 8 is attached to one surface of the heat conductive material 9, and the sample 10 is attached on the other surface.

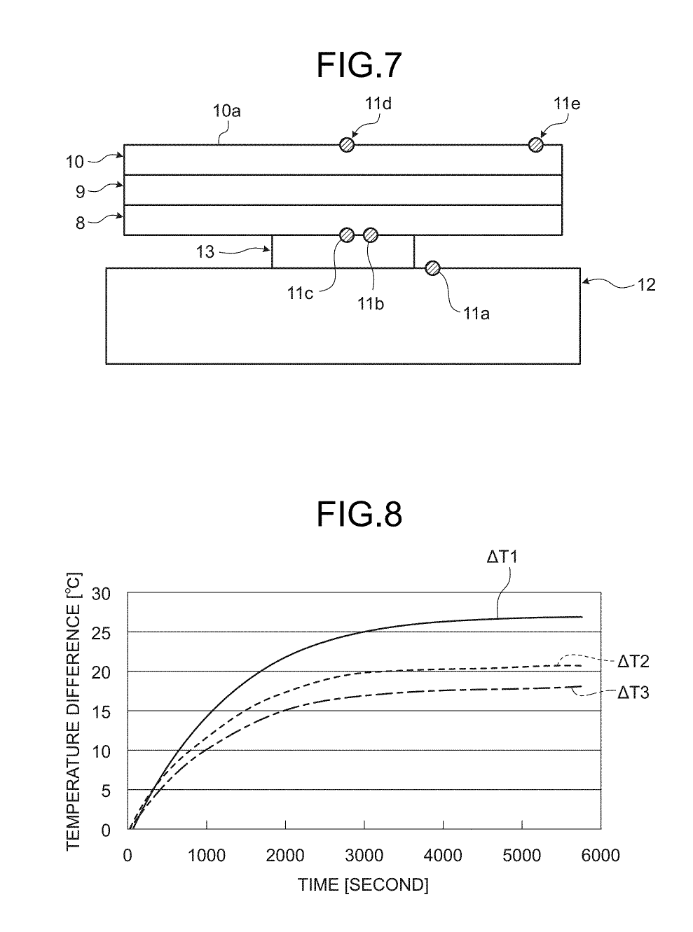

As illustrated in FIG. 7, the circuit board 8 is heated using a heater 12 and an aluminum piece 13. The aluminum piece 13 is used as a spot heat source. The aluminum piece 13 has a size of 20×50×5 [mm]. As the heat generated from the heater 12 is transferred to the circuit board 8 through the aluminum piece 13, radiation of the heat generated from the spot heat source is simulated. As the heater 12, a hot plate (Model No. PC-100) manufactured by CORNING Corporation was employed. As illustrated in FIG. 7, the heater 12 generates heat while the aluminum piece 13 is interposed between the heater 12 and the circuit board 8. The aluminum piece 13 is arranged in the center of the heating surface of the heater 12. The heat generated from the heater 12 is transferred to the center of the circuit board 8 from the aluminum piece 13. The heat of the circuit board 8 is transferred to the sample 10 through the heat conductive material 9 and is radiated from the sample 10.

The temperature of each of the portion is measured using thermocouples 11a, 11b, 11c, 11d, and 11e. The thermocouple 11a measures a temperature in the vicinity of a contact portion between the heater 12 and the aluminum piece 13. The thermocouple 11b measures a temperature of the aluminum piece 13. The thermocouple 11c measures a temperature in the vicinity of a contact portion between the circuit board 8 and the aluminum piece 13. The thermocouple 11d measures a temperature of the center of the outer surface 10a of the sample 10. The thermocouple 11e measures a temperature in the circumferential edge of the outer surface 10a. The measurement temperatures of the thermocouples 11a, 11b, 11c, 11d, and 11e were obtained using a data logger (Model No. LR800) manufactured by HIOKI E. E. Corporation. The data collection using the data logger was performed at an interval of 5 seconds. The temperatures were continuously measured from the start of heating of the heater 12 until the temperature of the circuit board 8 was saturated.

The temperature measurement was similarly performed for a sample 10 having no groove 66 in order to check a heat dissipation effect of the groove 66. A method or condition of the temperature measurement was similar to the aforementioned case except that no groove 66 is provided on the outer surface 10a of the sample 10. Furthermore, the temperature measurement was performed for a case where the circuit board 8 having no heat conductive material 9 and the sample 10 is heated. The heating method and the temperature measurement using the thermocouples 11a, 11b, and 11c are similar to the aforementioned case. The thermocouples 11d and 11e measure a temperature of the circuit board 8 instead of measurement of the temperature of the sample 10. The thermocouple 11d measures a temperature of the center of the outer surface of the circuit board 8. The thermocouple 11e measures a temperature of the circumferential edge of the outer surface of the circuit board 8.

FIG. 8 illustrates a change of the temperature difference calculated from each temperature measured as described above. In FIG. 8, the abscissa denotes time (seconds) elapsing from the start of the heating, and the ordinate denotes a temperature difference (° C.). Here, the temperature difference refers to a temperature difference between the measurement temperature of the thermocouple 11c and the measurement temperature of the thermocouple 11d. The temperature difference ΔT1 refers to a temperature difference when the sample 10 provided with the grooves 66 is employed. The temperature difference ΔT2 refers to a temperature difference when the sample 10 having no groove 66 is employed. The temperature difference ΔT3 refers to a temperature difference measured for the circuit board 8 on which the heat conductive material 9 and the sample 10 are not attached.

As illustrated in FIG. 8, in the case of the sample 10 where the grooves 66 are provided (ΔT1), the temperature difference between the temperature of the circuit board 8 and the temperature of the sample 10 increases, compared to the case where the sample 10 has no groove 66 (ΔT2). That is, the sample 10 provided with the grooves 66 has a higher heat dissipation capability, compared to a case where no groove 66 is provided. The temperature differences ΔT1_{—} and ΔT2 in the case of saturation were 26.80° C. and 20.85° C., respectively. That is, by providing the grooves 66, the temperature difference increases about 1.29 times. Therefore, the first busbar 6 provided with the grooves 66 on the outer surface 61a has a high heat dissipation capability similar to the sample 10. Similarly, the second busbar 7 provided with the grooves 66 on the second surface region 74b also has a high heat dissipation capability.

In the electric connection box 1 according to this embodiment, as illustrated in FIGS. 1 and 2, ventilation holes 2a and 2b are provided in the upper cover 2. The ventilation hole 2a is provided in a part facing the second surface region 64b of the first busbar 6, and the ventilation hole 2b is provided in a part facing the second surface region 74b of the second busbar 7. As a result, a temperature decrease in the vicinity of the first and second busbars 6 and 7 is promoted. Therefore, the heat dissipation capability using the first and second busbars 6 and 7 is improved.

As described above, the first and second busbars 6 and 7 as a conductive member according to this embodiment have the first surface regions 64a and 74a and the second surface regions 64b and 74b. The second surface regions 64b and 74b have a surface roughness value higher than those of the first surface regions 64a and 74a, respectively. Since the second surface regions 64b and 74b having a large ratio between the region area and the surface area are provided, the heat dissipation capability of the busbars 6 and 7 increases. Since the second surface regions 64b and 74b provided with the grooves 66 have a large heat dissipation area, the heat conductivity increases, and the heat transfer amount increases, so that the heat dissipation effect is high. In general, a heat transfer amount is calculated on a formula “heat transfer amount (W)=heat conductivity (W/° C.)×temperature difference (° C.).” The heat conductivity is proportional to the surface area (heat dissipation area). In the busbars 6 and 7 according to this embodiment, since the heat dissipation area increases, the heat transfer amount also increases. Therefore, the busbars 6 and 7 can radiate heat of other components electrically connected or other components existing in the vicinity with high efficiency as well as the heat generated from the busbars 6 and 7.

The busbars 6 and 7 also serve as a heat dissipation member as well as a path for supplying electric power as a conductive member. As a result, cooling performance for the circuit board 8 or the electric component 81 can be improved using the busbars 6 and 7 without adding a new heat dissipation member. Therefore, it is possible to suppress an increase of the number of components or cost, or reduce the size of the electric connection box 1. Furthermore, since the grooves 66 are provided on the second surface regions 64b and 74b, the weight of the busbars 6 and 7 can be reduced. As a result, it is possible to reduce the weight of the electric connection box 1.

The busbars 6 and 7 according to this embodiment have terminal portions 62 and 72, respectively, electrically connected to other components. The second surface regions 64b and 74b are set to exclude at least contact surfaces 62a and 72a for contact with other components. As a result, it is possible to improve stability of electric connection between the terminal portions 62 and 72 other components.

In the busbars 6 and 7 according to this embodiment, the second surface regions 64b and 74b are exposed to a surrounding space. In this manner, by arranging the second surface regions 64b and 74b in the region exposed to a surrounding space, it is possible to appropriately improve the heat dissipation capability.

The second surface regions 64b and 74b are subjected to surface finishing for increasing the surface roughness value of the plate member. Through the surface finishing, it is possible to appropriately control the heat dissipation capabilities of the busbars 6 and 7. For example, the position or range of the second surface region 64b or 74b, or a depth, width, or pitch of the groove 66 may be set such that a necessary temperature difference ΔT1 or higher is obtained. Note that the first surface regions 64a and 74a may be subjected to surface finishing or not. For example, surface finishing for improving stability of electric connection with other components may be performed for the first surface regions 64a and 74a.

The surface finishing for the first surface regions 64a and 74a according to this embodiment is an etching process. The etching process is advantageous to form a deep groove 66 or narrow the pitch of the groove 66.

The electric connection box 1 according to this embodiment has busbars 6 and 7 as a conductive member, and the upper and lower covers 2 and 3 as a casing. The busbars 6 and 7 provided with the second surface regions 64b and 74b suppress a temperature increase of the circuit board 8 or the electric component 81 inside the electric connection box 1. Therefore, the electric connection box 1 according to this embodiment appropriately suppresses a temperature increase in the internal components to protect the components. In addition, since the second surface regions 64b and 74b are provided in the busbars 6 and 7 as the conductive member, it is possible to improve the heat dissipation capability without adding a new dedicated heat dissipation member.

The upper cover 2 of the casing has ventilation holes 2a and 2b facing the second surface regions 64b and 74b. Due to a synergistic effect of the second surface regions 64b and 74b and the ventilation holes 2a and 2b, it is possible to more appropriately suppress a temperature increase of the components inside the electric connection box 1.

### FIRST MODIFICATION OF EMBODIMENT

A first modification of the embodiment will be described. The second surface regions 64b and 74b may include a region exposed to external space of the electric connection box 1. The first busbar 6 will be described with reference to FIG. 2 by way of example. The second surface region 64b may be set to include a part of the terminal portion 62. The terminal portion 62 is a part protruding to the outside from the upper cover 2. Since the terminal portion 62 is also provided with the second surface region 64b, it is possible to more improve the heat dissipation capability using the first busbar 6. In the terminal portion 62, the second surface region 64b is preferably set to exclude a contact portion with the terminal W11 and a contact portion with the terminal holding surface 32a. In addition, in the first busbar 6, the second surface region 64b may be set in a portion other than the outer surface 61a and the terminal portion 62. Similarly, the second surface region 74b may be set in the second busbar 7.

### SECOND MODIFICATION OF EMBODIMENT

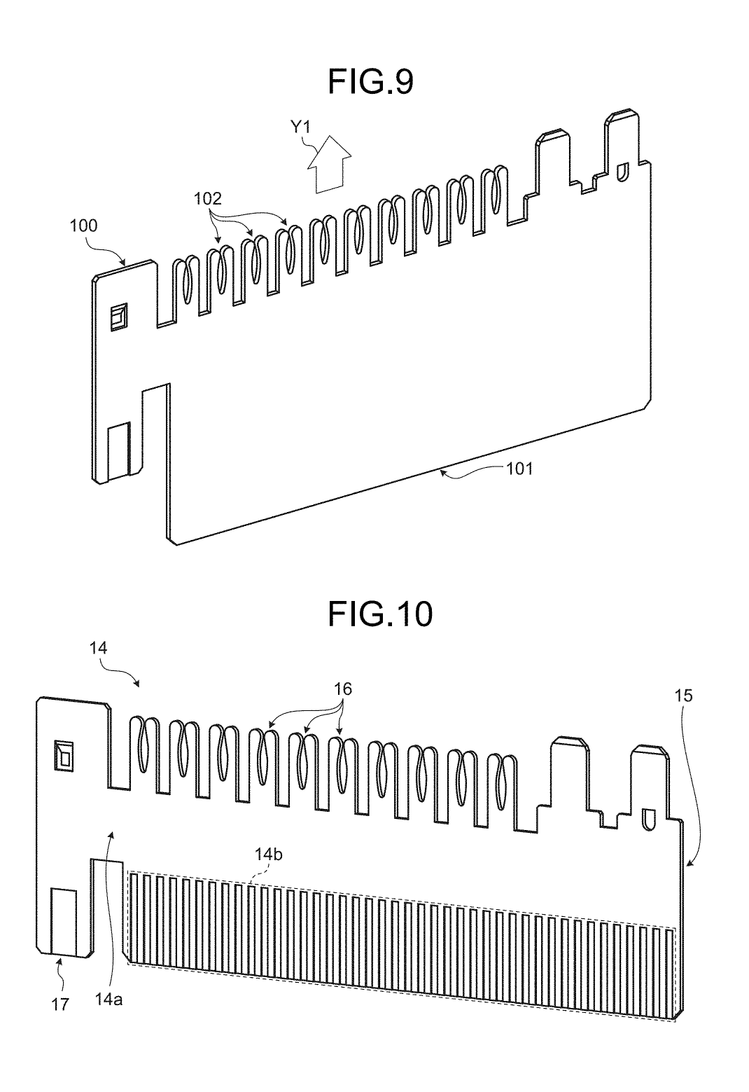

A second modification of the embodiment will be described. FIG. 9 is a perspective view illustrating a busbar of a comparative example, and FIG. 10 is a perspective view illustrating a busbar according to a second modification of the embodiment. The conductive member provided in the second surface region may be the busbar 100 illustrated in FIG. 9. This busbar 100 is inserted into and held in the casing of the electric connection box 1 or an internal block in a direction indicated by the arrow Y1. The busbar 100 has a tuning fork terminal portion 102. The tuning fork terminal portion 102 is electrically connected to the electric component. The tuning fork terminal portion 102 protrudes from one side of the tabular main body 101. The main body 101 serves as a heat dissipation portion that radiates the heat generated from the electric component.

A busbar 14 according to a second modification illustrated in FIG. 10 has a main body 15, a tuning fork terminal portion 16, and a terminal portion 17. The main body 15 is a rectangular tabular element. The terminal portion 17 is electrically connected to the power source and the like. The tuning fork terminal portion 16 is electrically connected to the electric component such as a relay. The busbar 14 has a first surface region 14a and a second surface region 14b. The second surface region 14b is at least a part of the main body 15. The second surface region 14b may be provided on both sides of the main body 15. The first surface region 14a is at least a part including the terminal portion 17 and the tuning fork terminal portion 16. The main body 15 provided with the second surface region 14b has a higher heat dissipation capability, compared to the main body 101 of the busbar 100 of the comparative example. Therefore, it is possible to obtain the same heat dissipation amount as that of the main body 101 of the comparative example even when the size of the main body 15 is reduced. Therefore, using the busbar 14 according to the second modification, it is possible to secure the heat dissipation capability and reduce the size.

### THIRD MODIFICATION OF EMBODIMENT

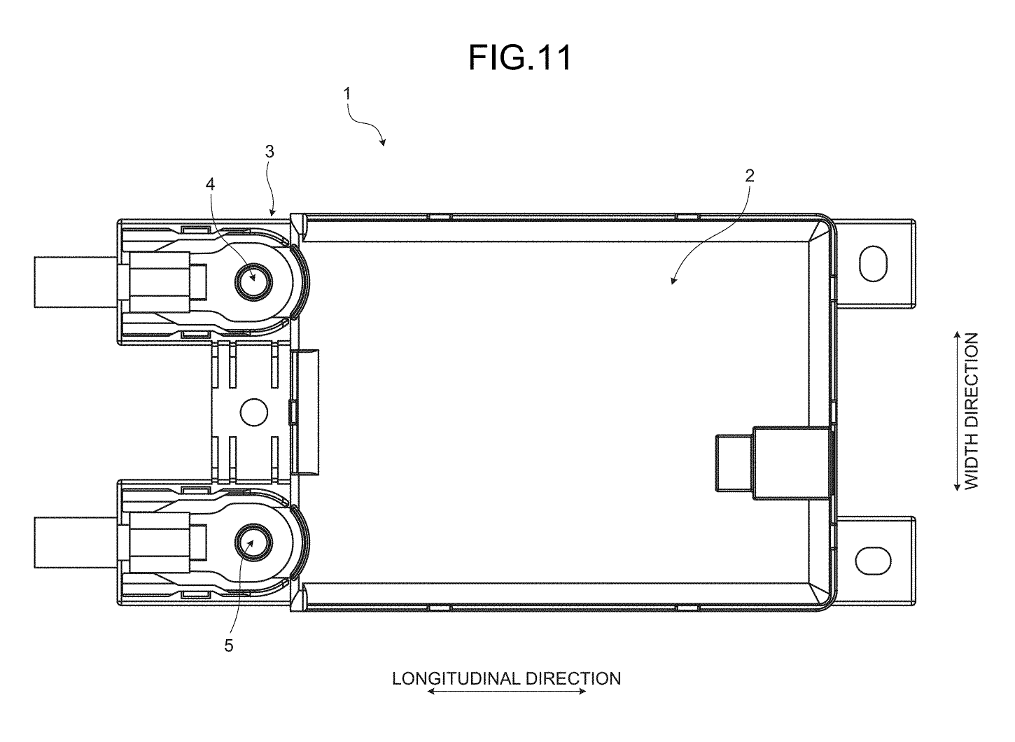

A third embodiment of the embodiment will be described. FIG. 11 is a plan view illustrating an electric connection box according to a third embodiment of the embodiment. The upper cover 2 of FIG. 11 does not have the ventilation holes 2a and 2b unlike the upper cover 2 of the aforementioned embodiment (FIG. 1). In this manner, even when the ventilation holes 2a and 2b are not provided, it is possible to appropriately suppress a temperature rise of the electric component 81 or the circuit board 8 by adjusting the heat dissipation capabilities of the busbars 6 and 7.

### FOURTH MODIFICATION OF EMBODIMENT

A fourth modification of the embodiment will be described. The surface finishing for the second surface regions 14b, 64b, and 74b is not limited to etching. For example, the surface finishing may be performed through laser machining, sand blasting, emboss patterning, or the like. In addition, the surface shape formed on the second surface regions 14b, 64b, and 74b through the surface finishing is not limited to the groove 66 described in the aforementioned embodiment. For example, another groove intersecting the grooves 66 may also be formed on the second surface regions 14b, 64b, and 74b in addition to the grooves 66. Furthermore, a plurality of concave portions may also be formed on the second surface regions 14b, 64b, and 74b through sand blasting or the like.

The conductive member provided with the second surface regions 14b, 64b, and 74b is not limited to the busbars 6, 7, and 14 described in the aforementioned embodiment. The conductive member is not limited to a member called the busbar, but may be another conductive member.

Suitable combinations may be possible for the embodiment and the modifications described above.

The conductive member according to the embodiments includes a conductive plate member having a first surface region and a second surface region having a surface roughness value higher than that of the first surface region. Using the conductive member according to the embodiments, it is possible to suppress an increase of the number of components and improve the heat dissipation capability.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conductive member comprising a conductive plate member including a first surface region and a second surface region having a surface roughness value higher than that of the first surface region.

2. The conductive member according to claim 1, further comprising:
a terminal portion electrically connected to other components, wherein
the second surface region is a region excluding at least a contact surface with the other components.

3. The conductive member according to claim 1, wherein
the second surface region is exposed to a surrounding space.

4. The conductive member according to claim 2, wherein
the second surface region is exposed to a surrounding space.

5. The conductive member according to claim 1, wherein
the second surface region is subjected to surface finishing for increasing a surface roughness value to the plate member.

6. The conductive member according to claim 2, wherein
the second surface region is subjected to surface finishing for increasing a surface roughness value to the plate member.

7. The conductive member according to claim 3, wherein
the second surface region is subjected to surface finishing for increasing a surface roughness value to the plate member.

8. The conductive member according to claim 5, wherein
the surface finishing is etching.

9. The conductive member according to claim 6, wherein
the surface finishing is etching.

10. The conductive member according to claim 7, wherein
the surface finishing is etching.

11. An electric connection box comprising:
a conductive member including a conductive plate member provided with a first surface region and a second surface region having a surface roughness value higher than that of the first surface region; and
a casing that houses the conductive member.

12. The electric connection box according to claim 11, wherein
the casing has a ventilation hole facing the second surface region.
